(19) United States
(12) Patent Application Publication
(10) Pub. No.: US 2013/0101782 A1
(43) Pub. Date: Apr. 25, 2013

(54) NONFLUORINATED SOIL AND STAIN RESIST COMPOSITIONS

(71) Applicant: E I DU PONT DE NEMOURS AND COMPANY, Wilmington, DE (US)

(72) Inventors: Joyce Monson Materniak, Hockessin, DE (US); Edward Patrick Carey, Alglen, PA (US); Melea Rena Langley, Ringgold, GA (US)

(73) Assignee: E I DU PONT DE NEMOURS AND COMPANY, Wilmington, DE (US)

(21) Appl. No.: 13/644,492

(22) Filed: Oct. 4, 2012

Related U.S. Application Data
(60) Provisional application No. 61/548,786, filed on Oct. 19, 2011.

(51) Int. Cl. C09D 5/00; B32B 33/00; B32B 9/02; B32B 23/04; B32B 29/00; C08K 5/41; B32B 9/00; B32B 27/28; B32B 27/40; C09D 137/00; C09D 133/10; C09D 175/06; B32B 5/02; D02G 3/36

(52) U.S. Cl. 428/96; 442/93; 428/473; 428/532; 428/537.5; 428/375; 428/704; 428/500; 428/446; 428/702; 428/423.1; 524/549; 524/558; 524/560; 106/2; 524/556; 524/156

(57) ABSTRACT

A composition comprising at least one of a surfactant, and at least one of a nonfluorinated soil resist agent, and at least one of a stain resist agent, said composition further optionally comprising an inorganic oxide; a method of imparting surface effects to substrates contacted therewith; and the resulting treated substrates.

### FIELD OF THE INVENTION

The present invention comprises nonfluorinated compositions for providing soil resistance and stain resistance to fibrous substrates treated therewith, a method of treating substrates to impart such surface effects, and the resulting treated substrates.

### BACKGROUND OF THE INVENTION

Polyfluorinated compositions are used in the preparation of a wide variety of surface treatment materials. Various materials made from perfluorinated compositions are known to be useful as surfactants or treating agents to impart surface effects to substrates. In particular, commercially successful products for providing soil resistance to fibrous substrates have traditionally contained long chained perfluoroalkyl groups.

It is known in the art that there is a relationship between chain length of perfluoroalkyls in surface treatment compositions and the surfaces properties imparted. See Honda et al., Macromolecules, 2005, Vol. 13, pp. 5699-5705, in particular p 5704. Long chain perfluoroalkyls of greater than or equal to 8 carbons align in a parallel manner in the crystalline state. Surface effects are related to the alignment in that highly ordered chains have low mobility. Shorter chain perfluoroalkyls of 2 to 6 carbons lose this alignment, have higher mobility, and have reduced contact angle measurements. Surface effect performance drops off when the chain length is shortened.

U.S. Pat. No. 4,883,839 of Fitzgerald et al. discloses a composition for imparting stain resistance to textile and carpet substrates comprising 1) a hydrolyzed copolymer of maleic anhydride and ethylenically unsaturated aromatic monomers, and 2) a sulfonated phenol-formaldehyde condensation product. The composition can be applied as an aqueous solution and the substrate does not suffer from yellowing to the extent that occurs with other known stain resist agents. Use of a separate fluorinated compound is taught in order to obtain soil resistance in the substrate.

U.S. Pat. No. 7,550,199 of Hopkins et al discloses a method for imparting stain resistance to a substrate comprising contacting the substrate with a copolymer made by reacting an amine with an alkene/maleic anhydride copolymer, and/or an alpha olefin/maleic anhydride copolymer. Use of a separate fluorinated compound is taught in order to obtain soil resistance in the substrate.

The two patents referenced above are directed to resistance to acid dye type stains, typically resulting from contact with foods and beverages. Both require the use of a separate fluorinated compound to obtain soil resistance.

In particular there is a need for surface treatment agents for providing soil resistance to substrates wherein some of the expensive fluorocarbon moieties have been replaced with less expensive and more readily biodegradable moieties. The present invention provides nonfluorinated surface treatment agents which are economical to manufacture while providing effective soil resistance to fibrous substrates, which can be used in combination with stain resist agents.

### BRIEF SUMMARY OF THE INVENTION

The present invention comprises a composition comprising at least one of a surfactant, at least one nonfluorinated soil resist agent, and at least one stain resist agent which imparts soil resistance and stain resistance to a substrate which has been contacted with said composition.

The present invention further comprises a method of providing soil resistance plus stain resistance to a substrate comprising contacting said substrate with a composition as described above.

The present invention further comprises a substrate treated in accordance with the method described above.

### DETAILED DESCRIPTION OF INVENTION

Hereinafter trademarks are designated by upper case.

“Soil resist agent” as used herein means a nonfluorinated composition applied to, or incorporated into, a substrate which retards and limits the build-up of dirt or soil on the surface of the substrate.

“Stain resist agent” as used herein means a composition applied to, or incorporated into, a substrate which imparts resistance to staining by acid dye type stains, such as food, beverage, or dye stains.

The present invention comprises a composition comprising at least one of a surfactant, at least one of a nonfluorinated soil resist agent, and at least one stain resist agent, which composition imparts soil resistance and stain resistance to a substrate which has been contacted with said composition. The present invention further comprises a composition comprising at least one of a surfactant, at least one of a nonfluorinated soil resist agent, and at least one stain resist agent, which further contains one or more of an inorganic oxide, water, or a combination thereof.

Other embodiments of the invention include a method of treating substrates to impart soil resistance and stain resistance by contacting with any of the above-described compositions of the invention, and the resulting treated substrates having surface properties. The compositions and methods of the present invention employ nonfluorinated agents to provide or impart soil resistance to substrates which is comparable to or improved versus that provided or imparted by prior art fluorinated soil resist agents.

In all embodiments of the present invention, the surfactant, the nonfluorinated soil resist agent, the stain resist agent, and the optional inorganic oxide, are present at weight percentages of each individual component that is used to prepare the compositions of the present invention. The surfactant is present from about 0.01% to from about 10% by weight. The nonfluorinated soil resist agent is present from about 0.1% to from about 30% by weight. The inorganic oxide is present from 0% to from about 30% by weight. The stain resist is present from about 0.1 to from about 30% by weight. The weight percentage of each component (surfactant, nonfluorinated soil resist agent, inorganic oxide, and stain resist agent) is chosen such that it is equal to any individual number within a weight range specified for each, and the sum of the combined components is equal to 100%. One skilled in the art can easily choose weight percentages for each component within the stated ranges so that the total equals 100%. For example, the surfactant is present at any of 0.01, 0.2, 0.3 and so on, up to 10% by weight; the nonfluorinated soil resist agent is present at any of 0.1, 0.2, 0.3 and so on up to 30% by weight; the inorganic oxide is present at any of 0, 0.1, 0.2, 0.3 and so on up to 30% by weight; and the stain resist agent is present at any of 0.1, 0.2, 0.3 and so on up to 30% by weight. The combination of any individual value for the surfactant from 0.01 to 10%, of any individual value for nonfluorinated soil resist agent from 0.1 to 30%, of any individual value for the inorganic oxide from 0 to 30% by weight, any individual value for the stain resist agent from 0 to 30% by weight, that totals 100% by weight is included within the present invention. For all combinations of components, if the values of the weight percentages selected do not add up to 100%, the remainder of the weight % of the composition is composed of water in an amount to make the total add up to 100% by weight.

In particular embodiments described below, the surfactant, the nonfluorinated soil resist agent, the inorganic oxide, and the stain resist agent are each equal to any individual value within the range cited for each of the surfactant, the nonfluorinated soil resist agent, the inorganic oxide, and the stain resist agent, respectively. The invention includes any combination of the individual values for the surfactant, the nonfluorinated soil resist agent, the inorganic oxide, the stain resist agent, and water, that total to 100%.

One embodiment of the present invention comprises a composition comprising at least one of a surfactant, at least one of a nonfluorinated soil resist agent, and at least one stain resist agent. Nonfluorinated soil resist agents suitable for use in the present invention include carboxylated polymers, an alkali metal salt of a hydrolyzed styrene/maleic anhydride copolymer, alkali metal salt of a hydrolyzed styrene/maleic anhydride/cumene terpolymer, an alkali metal salt of a hydrolyzed octene/maleic anhydride copolymer, an ammonium salt of a hydrolyzed styrene/maleic anhydride copolymer, an ammonium salt of a hydrolyzed styrene/maleic anhydride/cumene terpolymer; methyl methacrylate/ethyl methacrylate copolymer, polymethylmethacrylate, poly(methylmethacrylate)/polyethoxy ethyl methacrylate copolymer, polymethacrylic acid, polystyrene, sulfonated polyester, polyester, and a dispersion of inorganic particulate matter selected from amorphous silicon dioxide, colloidal silica, amorphous silica, clay, titanium dioxide, colloidal alumina, and zirconium oxide. Mixtures of any of the above soil resist agents are also suitable for use.

Preferred soil resist agents include polymethylmethacrylate, methyl methacrylate/ethyl methacrylate copolymer, an alkali metal salt of a hydrolyzed styrene/maleic anhydride copolymer or of a hydrolyzed styrene/maleic anhydride/cumene terpolymer, an ammonium salt of a styrene/maleic anhydride copolymer or of a hydrolyzed styrene/maleic anhydride/cumene terpolymer, amorphous silicon dioxide, colloidal silica, and amorphous silica. Hydrolyzed styrene/maleic anhydride copolymers, hydrolyzed octene/maleic anhydride copolymers, hydrolyzed styrene/maleic anhydride/cumene terpolymers, and the salts of each, are commercially available or are prepared by known methods, such as disclosed in U.S. Pat. Nos. 5,707,708 and 5,834,088, each herein incorporated by reference.

Suitable commercially available nonfluorinated soil resist agents include polymethylmethacrylate (E. I. du Pont de Nemours and Company, Wilmington, Del.), poly(methylmethacrylate)/polyethoxy ethyl methacrylate (E. I. du Pont de Nemours and Company, Wilmington, Del.), FLEXIPEL SR-30 (Innovative Chemical Technologies, Cartersville, Ga.), FLEXIPEL Q (Innovative Chemical Technologies, Cartersville, Ga.), ZELAN 338 (E. I. du Pont de Nemours and Company, Wilmington, Del.), ZELAN 8719 (E. I. du Pont de Nemours and Company, Wilmington, Del.), SMA1000 (Sartomer Company, Inc., Exton, Pa.), SMA 2625H (Sartomer Company, Inc., Exton, Pa.), PERMAGUARD ESR-2128 (Phoenix Chemical Company, Calhoun, Ga.), LUDOX HS-40 (W. L. Grace & Co., Columbia, Md.), NALCO 1050 (Nalco Company, Naperville, Ill.), NALCO 1034A (Nalco Company, Naperville, Ill.), NALCO 2327 (Nalco Company, Naperville, Ill.), NALCO 13573 (Nalco Company, Naperville, Ill.), SILTECH C-404, SILTECH C-101, SILTECH C-40, SILTECH C-20 (Siltech LLC, Dacula, Ga.).

Surfactants suitable for use in the composition of the present invention include surfactants selected from the group consisting of an alkali metal salt of alpha sulfonated carboxylic acid or ester; an alkali metal salt of 1-octane sulfonate; alkyl aryl sulfate; alkali metal alkyl diphenyloxide disulfonate; alkali metal salt of dimethyl-5-sulfoisophthalate; salt of butyl naphthalene sulfonate; salt of C₁₆-C₁₈ phosphate (such as potassium); salt of condensed naphthalene formaldehyde sulfonated (such as sodium); salt of dodecyl benzene sulfonate (branched) (such as sodium); salt of alkyl sulfate (such as sodium); alpha olefin sulfonate; salt of dodecyl diphenyloxide disulfonate; polyoxyethylene (20) cetyl ether; ethoxylated alcohol; alkyl dimethyl amine; polyoxyethylene tridecyl ether; dodecyl dimethyl ammonium acetate; alkali metal salts of sulfonated, 1,1-oxybis, tetrapropylene benzene, and anionic surfactants. Preferred surfactants include alpha olefin sulfonates and alkali metal salt of alkyl sulfate. Suitable commercially available nonfluorinated surfactants include ALPHA-STEP MC-48 (Stepan Company, Northfield, Ill.), ARMEEN DM12D (AkzoNobel, Chicago, Ill.), BIO-TERGE PAS-8S (Stepan Company, Northfield, Ill.), BRIJ 58 (Uniqema, New Castle, Del.), CENEGEN 7 (Yorkshire America, Charlotte, N.C.), DEXTROL Foamer 916 (Dexter Chemical L.L.C., Bronx, N.Y.), DOWFAX 2A1 (Dow Chemical Co., Midland, Mich.), ETHAL TDA-5 (Ethox Chemicals, LLC., Greenville, S.C.), NOPCOSPRSE 9268A (Henkel/Cognis, Cincinnati, Ohio), RHODAPON SB-82085 (Ashland Chemical Company, Columbus, Ohio), SUL-FON-ATE AA-10 (Tennessee Chemical Co., Atlanta, Ga.), ULTRAFOAM FFA-3 (Phoenix Chemical Company, Inc., Calhoun, Ga.), UNIFROTH 0448 (Unichem, Inc., Haw River, N.C.), WITCO C-6094 (Witco, Houston, Tex.), and WITCOLATE WAQE (Witco, Houston, Tex.).

Stain resist agents suitable for use in the present invention include an alkali metal salt of a hydrolyzed styrene/maleic anhydride copolymer, alkali metal salt of a hydrolyzed styrene/maleic anhydride/cumene terpolymer; an alkali metal salt of a hydrolyzed octene/maleic anhydride copolymer; ammonium salt of a hydrolyzed styrene/maleic anhydride copolymer, ammonium salt of a hydrolyzed styrene/maleic anhydride/cumene terpolymer; carboxylated polymer; a blend of carboxylated polymer and sulfonated aromatic condensate; a blend of sulfonated aromatic condensate and an alkali metal salt of hydrolyzed styrene/maleic anhydride copolymer or of a hydrolyzed styrene/maleic anhydride/cumene terpolymer; a blend of sulfonated aromatic condensate and an alkali metal salt of hydrolyzed octene/maleic anhydride copolymer; sulfonated aromatic condensate; aqueous solution of sulfonated phenolic resin; methylene-linked condensate of aromatic sulfonic acid and hydroxyaryl sulfone; naphthalene sulfonic acid, polymer of formaldehyde and 4,4′ sulfonyl bis[phenol]; aromatic sulfonates; propyl ester of styrene maleic anhydride resin; ammonium salt of styrene maleic anhydride resin; homopolymer or copolymer of methacrylic acid; anionic polymer; and anionic polymer resin.

Suitable commercially available stain resist agents include SR-500 (E. I. du Pont de Nemours and Company, Wilmington, Del.); SR-525 (E. I. du Pont de Nemours and Company, Wilmington, Del.); NRD-329 (E. I. du Pont de Nemours and Company, Wilmington, Del.); ZELAN 338 (E. I. du Pont de Nemours and Company, Wilmington, Del.); ZELAN 8719 (E. I. du Pont de Nemours and Company, Wilmington, Del.); STARBLOCK 40 (StarChem, Wellford, S.C.); FX-657 (Minnesota Mining and Manufacturing Co., St.Paul, Minn.); FLEXISPERSE SB 210 (Innovative Chemical Technologies, Cartersville, Ga.); PERMAGUARD ESR-2128 (Phoenix Chemical Company, Calhoun, Ga.); ERIONAL LYN (Ciba Specialty Chemicals, High Point, N.C.); SMA-1000 (Sartomer Company, Exton, Pa.); SMA-2625H (Sartomer Company, Exton, Pa.); and BAYPROTECT DT (StarChem, LLC, Wellford, S.C.). Preferred stain resist agents include sulfonated aromatic condensate, a blend of carboxylated polymer and sulfonated aromatic condensate, an alkali metal salt of a hydrolyzed styrene/maleic anhydride copolymer or of a hydrolyzed styrene/maleic anhydride/cumene terpolymer, and anionic polymer.

The soil resist agent is present in the composition at from about 0.1 to about 30.0% by weight. Preferably the soil resist agent is present at from about 0.1 to about 20.0% by weight. More preferably the soil resist agent is present at from about 0.1 to about 15% by weight. The surfactant is present in the composition at from about 0.01 to about 10.0% by weight. Preferably the surfactant is present at from about 0.01 to about 5.0% by weight. More preferably the surfactant is present at from about 0.05 to about 4% by weight. The stain resist agent is present in the composition at from about 0.1 to about 30.0% by weight. Preferably the stain resist agent is present at from about 0.1 to about 20.0% by weight, more preferably at from about 0.2 to about 10% by weight.

The soil resist agent is typically present at about 0.2, 0.4, 0.5, 0.8, 1.0, 1.5, 2.0, 2.5, 3.0, 4.0, 5.0, or 6.0% by weight, and any one of these amounts of soil resist agent are present in combination with any of about 0.05, 0.10, 0.20, 0.30, 0.40, 0.50, 0.60, 0.70, 0.80, 1.0, 1.5, 2.0, or 2.5% by weight surfactant. The stain resist agent is typically present at 0.3, 0.4, 0.5, 1.0, 2.0, 3.0, 4.0, 5.0 or 6.0 weight %, in combination with any one of 0.2, 0.4, 0.5, 0.8, 1.0, 1.5, 2.0, 3.0, 4.0, 5.0, or 6.0% by weight soil resist agent; and any one of 0.02, 0.05, 0.10, 0.20, 0.30, 0.40, 0.50, 0.60, 0.70, 0.80, 1.0, 1.5, 2.0, or 2.5% by weight surfactant. The remainder of each composition is water.

A further embodiment of the present invention is a composition comprising at least one of a surfactant, at least one of a nonfluorinated soil resist agent, at least one of a stain resist agent, and at least one of an inorganic oxide, wherein the inorganic oxide also acts as a soil resist agent. Inorganic oxides suitable for use in the present invention include a stable dispersion of inorganic particulate matter selected from the group consisting of clay, colloidal silica, titanium dioxide, colloidal alumina, zirconium oxide, amorphous silicon dioxide, and colloidal silica dioxide. Preferred inorganic oxides include amorphous silicon dioxide and colloidal silica dioxide. The inorganic oxide is present in the composition at from about 0 to about 30.0% by weight. The soil resist agent and surfactant are defined as previously described.

Suitable inorganic oxides include LUDOX HS-40 commercially available from Grace Division, Columbia, Md.; NALCO 1050 commercially available from Nalco, Naperville, Ill.; NALCO 1034A commercially available from Nalco, Naperville, Ill.; NALCO 2327 commercially available from Nalco, Naperville, Ill.; NALCO 13573 commercially available from Nalco, Naperville, Ill.; and SILTECH C-404, SILTECH C-101, SILTECH C-40, SILTECH C-20 each commercially available from Siltech LLC, Dacula, Ga.

The soil resist agent, stain resist agent, and surfactant are present in the composition at the weight percent ranges described above. The inorganic oxide is present at from about 0% to about 30% % by weight. More preferably the inorganic oxide is present at from about 0.1% to about 20% by weight, even more preferably from about 0.15% to about 15% by weight, and even more preferably from about 0.2% to about 10% by weight. For example, typically the composition of the present invention contains inorganic oxide at about 0.3, 0.5, 1.0, 1.5, 2.0, 2.5, 3.0, 3.5, 4.0, 4.5, 5.0, 6.0, 7.0, or 8.0% by weight in combination with any one of 0.2, 0.4, 0.5, 0.8, 1.0, 1.5, 2.0, 3.0, 4.0, 5.0, or 6.0% by weight soil resist agent, any one of 0.3, 0.4, 0.5, 1.0, 2.0, 3.0, 4.0, 5.0 or 6.0% by weight stain resist agent, and any one of 0.02, 0.05, 0.10, 0.20, 0.30, 0.40, 0.50, 0.60, 0.70, 0.80, 1.0, 1.5, 2.0, or 2.5% by weight surfactant. The remainder of each composition is water.

A further embodiment of the present invention is a composition comprising at least one of a surfactant, at least one of a nonfluorinated soil resist agent, at least one stain resist agent, at least one additional component, and optionally at least one inorganic oxide. Additional components, designated herein “functional additives”, may be included for purposes such as to improve stability of the composition, for pH adjustment, or for freeze/thaw stability. Functional additives suitable for use in the present invention include soy protein commercially available from Protein Technologies International, Inc.; dipropylene glycol methyl ether commercially available from Lyondell, Houston, Tex.; 1,3-propanediol commercially available from E. I. du Pont de Nemours and Company, Wilmington, Del.; para-toluene sulfonic acid commercially available from Sigma Aldrich USA, St. Louis, Mo.; maleic anhydride solution commercially available from Sigma Aldrich USA, St. Louis, Mo.; citric acid commercially available from Continental Chemical and other sources; or polyester polyurethane dispersion commercially available from Bayer Material Science LLC, Pittsburgh, Pa.. Preferred additional components include 1,3-propanediol, para-toluene sulfonic acid, maleic anhydride solution, and citric acid.

The functional additive is present in the composition at from about 0 to about 10.0% by weight. Preferably the functional additive is present at from about 0.05 to about 5.0% by weight, more preferably from about 0.05 to about 2.0% by weight. The soil resist agent, surfactant, stain resist agent, and optional inorganic oxide are each as previously described, and present in amounts as previously described.

For example, typically the composition of the present invention contains 0.05, 0.10, 0.15, 0.20, 0.50, 0.75, 1.0, or 1.2 weight % of the functional additive, in combination with any one of 0.3, 0.4, 0.5, 1.0, 2.0, 3.0, 4.0, 5.0, or 6.0 weight % stain resist agent; any one of 0.2, 0.4, 0.5, 0.8, 1.0, 1.5, 2.0, 2.5, 3.0, 4.0, 5.0, or 6.0% by weight soil resist agent; any one of 0.02, 0.05, 0.10, 0.20, 0.30, 0.40, 0.50, 0.60, 0.70, 0.80, 1.0, 1.5, 2.0, or 2.50% by weight surfactant; and any one of 0, 0.3, 0.5, 1.0, 1.5, 2.0, 2.5, 3.0, 3.5, 4.0, 4.5, 5.0, 6.0, 7.0 or 8.0% by weight inorganic oxide. The remainder of each composition is water.

The compositions of the present invention are prepared by physically blending the individual components, or aqueous solutions or dispersions of the individual components. Such blending is achieved by conventional means, such as by mixing or homogenization.

Preferred compositions of the present invention include the following:
1) polymethylmethacrylate, sodium alkyl sulfate surfactant, and sodium salt of hydrolyzed styrene/maleic anhydride/cumene terpolymer;
2) polymethylmethacrylate, sodium alkyl sulfate surfactant, sodium salt of hydrolyzed styrene/maleic anhydride/cumene terpolymer, and amorphous silicon dioxide;
3) sulfonated aromatic condensate, sodium alkyl sulfate surfactant, sodium salt of hydrolyzed styrene/maleic anhydride/cumene terpolymer, and bio-based 1,3-propanediol;
4) sulfonated aromatic condensate, sodium alkyl sulfate surfactant, sodium salt of hydrolyzed styrene/maleic anhydride/cumene terpolymer, amorphous silicon dioxide, and citric acid;
5) sulfonated aromatic condensate, sodium alkyl sulfate surfactant, sodium salt of hydrolyzed styrene/maleic anhydride/cumene terpolymer, and amorphous silicon dioxide;
6) sulfonated aromatic condensate, alpha olefin sulfonate surfactant, an alkali metal salt of hydrolyzed octene/maleic anhydride copolymer, amorphous silicon dioxide, and citric acid;
7) sodium alkyl sulfate surfactant, sodium salt of hydrolyzed styrene/maleic anhydride/cumene terpolymer, and amorphous silicon dioxide.

For a one-step application of treatment agent to obtain both soil resistance and stain resistance in fibrous substrates, when the application is applied at the mill or manufacturing facility with oven or heat curing, the following compositions are preferred:
1) 2.4 weight % polymethylmethacrylate, 0.52 weight % sodium alkyl sulfate surfactant, and 4.0 weight % sodium salt of hydrolyzed styrene/maleic anhydride/cumene terpolymer;
2) 2.4 weight % polymethylmethacrylate, 0.52 weight % sodium alkyl sulfate surfactant, 4.0 weight % sodium salt of hydrolyzed styrene/maleic anhydride/cumene terpolymer, and 3.2 weight % amorphous silicon dioxide;
3) 2.0 weight % sulfonated aromatic condensate, 0.32 weight % sodium alkyl sulfate surfactant, 2.4 weight % sodium salt of hydrolyzed styrene/maleic anhydride/cumene terpolymer, and 1.2 weight % bio-based 1,3-propanediol;
4) 2.0 weight % sulfonated aromatic condensate, 0.64 weight % sodium alkyl sulfate surfactant, 2.4 weight % sodium salt of hydrolyzed styrene/maleic anhydride/cumene terpolymer, 1.4 weight % amorphous silicon dioxide, and 0.8 weight % citric acid;
5) 2.0 weight % sulfonated aromatic condensate, 0.64 weight % sodium alkyl sulfate surfactant, 2.4 weight % sodium salt of hydrolyzed styrene/maleic anhydride/cumene terpolymer, and 1.4 weight % amorphous silicon dioxide;
6) 2.0 weight % sulfonated aromatic condensate, 0.6 weight % alpha olefin sulfonate surfactant, 2.0 weight % alkali metal salt of hydrolyzed octene/ maleic anhydride copolymer, 1.4 weight % amorphous silicon dioxide, and 0.8 weight % citric acid.

For a one-step application of treatment agent to obtain both soil resistance and stain resistance in a fibrous substrate, when the application is applied after manufacture, such as at a sales facility or after installation, with air curing, preferred compositions comprises
1) 2.4 weight % polymethylmethacrylate, 0.52 weight % sodium alkyl sulfate surfactant, and 4.0 weight % sodium salt of hydrolyzed styrene/maleic anhydride/cumene terpolymer:
2) 2.4 weight % polymethylmethacrylate, 0.52 weight % sodium alkyl sulfate surfactant, 4.0 weight % sodium salt of hydrolyzed styrene/maleic anhydride/cumene terpolymer, and 3.2 weight % amorphous silicon dioxide:
3) 0.52 weight % sodium alkyl sulfate surfactant, 4.0 weight % sodium salt of hydrolyzed styrene/maleic anhydride/cumene terpolymer, and 3.2 weight % amorphous silicon dioxide:
4) 0.16 weight % sodium alkyl sulfate surfactant, 1.2 weight % sodium salt of hydrolyzed styrene/maleic anhydride/cumene terpolymer, 1.0 weight % sulfonated aromatic condensate, and 0.4 weight % citric acid:
5) 0.32 weight % alpha olefin sulfonate surfactant, 2.4 weight % sodium salt of hydrolyzed styrene/maleic anhydride/cumene terpolymer, 2.0 weight % sulfonated aromatic condensate, and 0.8 weight % citric acid.

The compositions of the present invention as defined above are useful to impart surface effects to substrates without the use of fluorinated components. Such surface effects include soil resistance plus stain resistance. The compositions of the present invention have the advantage of providing surface effects to substrates without the presence of the expensive fluorine component, and thus are more economical.

The present invention further comprises a method of imparting or providing soil resistance plus stain resistance to a substrate comprising contacting said substrate with a composition of the invention as described above. The composition of the present invention is contacted with suitable substrates by a variety of customary procedures. It is understood that the composition can be diluted prior to contacting with the substrate in the present method. For use on fibrous substrates, one can apply the composition from a dispersion by brushing, dipping, spraying, padding, roll coating, foaming or the like. Other suitable application techniques include exhaustion, flex-nip, nip, skein, winch, liquid injection, immersion, or overflow flood. The composition can be applied to dyed or undyed substrates, scoured or unscoured substrates, substrates containing pigmented yarn, and can also be applied by use of the conventional beck dyeing procedure, continuous dyeing procedures or thread-line application. The composition can be applied to installed carpet or textile, and to installed carpet or textile after a cleaning such as hot water extraction or low moisture cleaning For paper or leather substrates the method includes addition of the composition during processing, such as to the paper pulp, or to the leather processing solutions. After contacting, soil resistance and stain resistance are provided to the treated substrate. The stain resist agent is applied using conventional techniques before, after, or simultaneously with the soil resist agent.

The compositions used in the method of this invention are contacted with the substrate as such, or in combination with other finishes, processing aids, foaming compositions, lubricants, anti-stains, and the like. Such optional additional components include treating agents or finishes to achieve additional surface effects, or additives commonly used with such agents or finishes such as surfactants, pH adjusters, cross linkers, wetting agents, wax extenders, and other additives known by those skilled in the art. Such additional components can comprise compounds or compositions that provide surface effects such as no iron, easy to iron, shrinkage control, wrinkle free, permanent press, moisture control, softness, strength, anti-slip, anti-static, anti-snag, anti-pill, stain repellency, stain release, soil release, water repellency, oil repellency, odor control, antimicrobial, sun protection, cleanability and similar effects. One or more of such treating agents or finishes are applied to the substrate before, after, or simultaneously with the soil resist composition used in the method of the present invention.

The optimal treatment for a given substrate depends on (1) the characteristics of the nonfluorinated composition of the present invention, (2) the characteristics of the surface of the substrate, (3) the amount of nonfluorinated composition applied to the surface, (4) the method of contacting of the nonfluorinated composition onto the surface, and many other factors. Some nonfluorinated compositions work well on many different substrates, while others exhibit superior performance on some substrates or require higher loading levels. One skilled in the art can optimize the recommended compositions for specific situations as detailed above.

Optionally a blocked isocyanate to further promote durability can be added to the composition of the present invention (i.e., as a blended isocyanate). An example of a suitable blocked isocyanate is HYDROPHOBAL HYDORPHOBOL XAN commercially available from Ciba Specialty Chemicals, High Point, N.J. Other commercially available blocked isocyanates are also suitable for use herein. The desirability of adding a blocked isocyanate depends on the particular application for the treating agent. For most of the presently envisioned applications, it does not need to be present to achieve satisfactory cross-linking between chains or bonding to the substrate. However, it can be useful when treating textiles. When added as a blended isocyanate, amounts up to about 20% by weight can be added.

Optionally, non-fluorinated extender compositions can also be included in the application composition to obtain some combination of benefits. Examples of such an optional additional extender polymer composition are those disclosed in U.S. Pat. Nos. 7,344,758; 7,652,112; and 7,652,112.

For fibrous substrates, the soil resist agent is present in the composition at from about 0.1 to about 30.0% by weight. Preferably the soil resist agent is present at from about 0.2 to about 20.0% by weight. The surfactant is present in the composition at from about 0.01 to about 10.0% by weight. Preferably the surfactant is present at from about 0.01 to about 5.0% by weight. The stain resist agent is present in the composition at from about 0.1 to about 30.0% by weight. Preferably the stain resist agent is present at from about 0.1 to about 20.0% by weight. The total number of functional additives is present in the composition at from about 0 to about 10.0% by weight.

In the case of a carpet or textile substrate, the “wet pick up” is the weight of the composition applied to the carpet or textile, based on the dry weight of the carpet or textile face fiber. A low wet pickup bath system can be interchanged with low wet pickup spray or foam systems, and a high wet pickup bath system can be interchanged with other high wet pickup systems, e.g., flex-nip system, foam, pad, or flood. The method employed determines the appropriate wet pickup and whether the application is made from one side of the carpet or textile (spray and foam applications) or both sides (flex-nip and pad). The following Table 1 provides typical process specifications for application to carpet or textile substrates.

TABLE 1
Typical Wet Pickup Range for Various Applications

| Application | Wet Pickup Range - % |
|---|---|
| Flex-nip | 150-350 |
| Flood | 100-500 |
| Foam | 5-300 |
| Pad | 100-500 |
| Spray | 5-300 |

The dispersion or solution of the composition of the present invention is diluted for application. Many variations of the conditions for spray, foam, flex-nip, flood, and pad applications are known to those skilled in the art and the preceding conditions are provided as examples and are not intended to be exclusive. The dispersion or solution of the present invention is typically applied to a carpet or textile at a wet pickup of about 5% to about 500%, and preferably cured at from about 220° F. (104° C.) to about 260 (127° C.). Alternatively, the treated carpet or textile can be air dried. Optionally the carpet or textile can be pre-wetted before application of the dispersion or solution of the present invention. To pre-wet the carpet or textile, it is immersed in water and the excess water suctioned off.

For leather substrates, the composition of the present invention is applied by spraying onto dry or semi-wet hides, or immersion of leather into the composition of the present invention. The composition is applied during processing, or applied after completion of the normal tanning, retanning, or dying processes. It is preferred to combine the application of the composition of the present invention with the manufacturing process during the final stages of leather manufacture. For paper substrates the composition of the present invention is typically added to the paper pulp during processing.

The method of the present invention provides resistance to early soiling and staining to the treated substrates without the use of fluorinated compounds versus use of prior art fluorochemical soil resist compositions. The method can be conducted at a mill or manufacturing facility, by a retailer, or by an installer, or after installation or sale. In the method of the present invention the treating composition can also be applied to a substrate by a pump spray or as an aerosol. When applied as an aerosol, the present invention further comprises a propellant. Any propellant that is compatible with the composition used in the method of this invention can be employed, including but not limited to hydrocarbons, inorganic gases, or combinations thereof.

The present invention further comprises a substrate treated with or contacted with a soil resist and stain resist composition, said composition comprising any of the compositions of the present invention as described above. Suitable substrates for use with the composition and method of the present invention are fibrous substrates. Fibrous substrates include generally carpet, rugs, textiles, leather, paper, nonwovens, and other cellulosics. Examples of such substrates include films, fibers, yarns, fabrics, carpeting, paint brushes, paint rollers, paint applicators, and other articles made from filaments, fibers, or yarns derived from natural, modified natural, or synthetic polymeric materials or from blends of these with other fibrous materials. Specific representative examples are cotton; wool; silk; nylon including nylon 6, nylon 6,6 and aromatic polyamides; polyesters including poly(ethyleneterephthalate) and poly(trimethylene-terephthalate) (abbreviated PET and PTT, respectively); poly(acrylonitrile); polyolefins; paper; leather; jute; sisal; and other cellulosics. Further suitable substrates include nonwoven substrates, for example, spunlaced nonwovens, such as SONTARA available from E. I. du Pont de Nemours and Company, Wilmington, Del., and spunbonded-meltblown-spunbonded nonwovens. The compositions of this invention impart soil resistance and stain resistance properties to fibrous substrates. The preferred substrates of the present invention are carpeting, rugs, textiles, and nonwovens.

The compositions, methods, and substrates of the present invention provide several advantages. Compositions of the present invention impart soil resistance and stain resistance when applied to fibrous substrates without the use of fluorinated compounds. The methods of the present invention provide for the treatment of fibrous substrates to impart soil resistance plus stain resistance. Also provided are fibrous substrates which have excellent performance when compared to those treated with existing prior art fluorinated treatment compositions. The treated substrates have a wide variety of industrial and consumer uses, such as in carpets, rugs, draperies, furnishings, fabrics, uniforms, paint applicators, clothing, and other uses, where soil resistance and other surface effects are an advantage.

### Test Methods and Materials

The following materials, obtained from the sources listed, were used in the Examples herein.

A. Surfactants
1) UNIFROTH 0448 (Unichem Inc., Haw River, N.C.)

B. Soil resist agents
1) RUCO EPV 2058 (Rudolf Chemie, Geretsried, Germany)
2) ZP 9237 (Rudolf Chemie, Geretsried, Germany)
3) SILSURF A004 (Siltech LLC, Dacula, Ga.)
4) SILSURF A008 (Siltech LLC, Dacula, Ga.)
5) SILSURF A012 (Siltech LLC, Dacula, Ga.)
6) ZELAN 338 (E. I. du Pont de Nemours and Company, Wilmington, Del.)

C. Stain resist agents
1) ERIONAL LYN (Ciba Specialty Chemicals, High Point, N.C.)
2) 3M FX-657 (Minnesota Mining and Manufacturing Co., St. Paul, Minn.)
3) PERMAGUARD ESR-2128 (Phoenix Chemical Company, Inc., Calhoun, Ga.)
4) Alkali metal salt of hydrolyzed styrene maleic anhydride terpolymer (E. I. du Pont de Nemours and Company, Wilmington, Del.)
5) Alkali metal salt of hydrolyzed octene/maleic anhydride copolymer and sulfonated phenolic resin prepared as described in U.S. Pat. No. 5,654,068.

The following application methods and test methods were used in the Examples herein.

### Application Method A

The treatment was applied as an aqueous composition by spray application to the carpet at 25% wet pick-up (wpu) and dried to a carpet face temperature of 250° F. (121° C.). The carpet was either wet or dry prior to the application treatment.

### Application Method B

The treatment was applied as an aqueous composition by spray application to the carpet at 25% wet pick-up (wpu) and is air dried (no heat cure is used).

The carpet was either damp from a cleaning or pre-spray, or dry prior to the application treatment.

### Application Method 1

Dyed residential carpet was 4 inch weighed as a dry carpet sample. The carpet weight ranges from 10-20 grams each. Each carpet sample was saturated with water and then most of the water in the carpet was removed by mechanical means (such as by spin-drying using a centrifuge extractor) until the weight of water remaining in the carpet was about 20-40% of the dry carpet weight. Application baths of the non-fluorinated compositions were diluted to 2-4% loading on weight of fiber (owf) and adjusted to pH 2 with Auto Acid A-10 commercially available from Peachstate Labs, Rome, Ga. The diluted composition was applied to the carpet at 325% wet pick up (wpu). The weight of dry carpet sample (grams)×325%=grams of diluted composition to be applied to the carpet. The diluted composition was applied evenly to the wetted carpet sample and manually worked into the substrate using hands until the substrate was fully saturated. A single layer of one or more of the treated carpet samples was placed on the bottom of a microwave-safe plastic tray (any microwaveable plastic tray of adequate size may be used) with the pile side up. A few holes were punctured in the lid to prevent steam buildup, and the lid was placed on the plastic tray. Using a household microwave oven with a temperature probe (such as a General Electric model JVM1660, from General Electric, Schenectady N.Y.), the carpet was heated in the plastic tray at full power level until the temperature reached 195±2° F. (91±1° C.); the temperature was held at that level for 2 minutes. The microwave oven temperature probe was used to control the temperature. The samples were then rinsed thoroughly with water. Most of the water in the carpet sample was removed by spin-drying with an extractor until the weight of water remaining in the carpeting was about 20 to 40% of the dry carpet weight. The carpet sample was then completely dried in an oven at 90° C. for approximately 30 minutes. The carpet samples were allowed to cool completely, reaching equilibrium with the room environment before proceeding with end-use testing.

### Application Method 3

Dyed carpet was used. The diluted composition was made up at 1 part composition to 15 parts water (6.25% solution). First, the carpet samples were hot water extracted using a household extraction unit (such as BISSELL LITTLE Green, Model #1425-2 commercially available from Bissell, Inc., Grand Rapids, Mich. Hot water was sprayed onto the carpet samples and extracted immediately with the same pass over the carpet in all four directions to equal four total extraction passes. The second step was to apply the diluted composition to the carpet at a rate of 1 gallon of diluted composition per 200 sq. ft. (18.6 sq. m.) of carpet. The diluted composition was applied using a hand-held sprayer. For an 8-inch×12-inch (20.8 cm×30.5 cm) piece of carpet, 12.62 g of diluted composition were sprayed evenly onto the carpet sample. The carpet samples were then combed in each direction to equal four total passes using a standard carpet comb; this enables an even distribution and deeper penetration. After the treatment and combing, the carpet samples were allowed to air dry for 48 hours on a flat, non-absorbent surface. The carpet samples must be completely dry before proceeding with end-use testing.

### Test Method 1—Accelerated Soiling Test

A drum mill (on rollers) was used to tumble synthetic soil onto the carpet. Synthetic soil was prepared as described in AATCC Test Method 123-2000, Section 8. Synthetic soil, 3 g, and 1 liter of clean nylon resin beads ( 3/16 inch (0.32-0.48 cm) diameter ZYTEL 101 nylon resin beads, commercially available from E. I. du Pont de Nemours and Company, Wilmington, Del., were placed into a clean, empty canister. The canister lid was closed and sealed and the canister rotated on rollers for 5 minutes. The soil-coated beads were removed from the canister.

Total carpet sample size was 8×24 inch (20.3×60.9 cm). One test item and one control item were tested simultaneously. The carpet pile of all samples was laid in the same direction. Strong adhesive tape was placed on the backside of the carpet pieces to hold them together. The carpet samples were placed in the clean, empty drum mill with the tufts facing toward the center of the drum. The carpet was held in place in the drum mill with rigid wires. Soil-coated resin beads, 250 ml, and 250 ml of 5/16 in. diameter ball bearings (0.79 cm.), prepared as described above, were placed into the drum mill. The drum mill lid was closed and sealed. The drum was run on the rollers for 2½ minutes at 105 rpm. The rollers were stopped and the direction of the drum mill reversed. The drum was run on the rollers for an additional 2½ minutes at 105 rpm. The carpet samples were removed and vacuumed uniformly with 5 passes in each direction to remove excess dirt. The Delta E color difference for the soiled carpet was measured for the test and control items versus the unsoiled carpet for each item.

Color measurement of each carpet was conducted on the carpet following the accelerated soiling test. For each test sample and control sample the color of the carpet was measured, the sample was soiled, and the color of the soiled carpet was measured. The Delta E was the difference between the color of the soiled and unsoiled samples. Color difference was measured on each item, using a Minolta Chroma Meter CR 410 Minolta Corporation, Ramsey, N.J.). Color readings were taken at three different areas on the carpet sample, and the average Delta E was recorded. The control carpet for each test item was of the same color and construction as the test item.

Delta Delta E was calculated by subtracting the Delta E of the control carpet from the Delta E of the test item. A larger negative value for Delta Delta E indicated that the test carpet had better performance and less soiling than the control. A larger positive value for Delta Delta E indicated that the test carpet had poorer performance and soiled more than the control.

### Test Method 2—Floor Traffic Soil Test

Carpets were installed in a busy corridor of a school or office building and subjected to human foot traffic in a controlled test area. The corridor was isolated from exits and had substantial walk-off mats and carpeted areas prior to the soiling test area. The unit “foot traffic” was the passing of one individual in either direction and was recorded with automated traffic counters. A Delta Delta E measurement was made as in Test Method 1.

Test Method 4: Stain Test with Cherry KOOL-AID

Cherry KOOL-AID, a trademark of Kraft General Foods, Inc., White Plains, N.Y., stain testing was conducted on carpet samples 3.9-inch×3.9-inch (10 cm.×10 cm). Acid dye stain resistance was evaluated using a procedure based on the American Association of Textile Chemists and Colorists (AATCC) Method 175, “Stain Resistance: Pile Floor Coverings.” A staining solution was prepared by mixing 36.5 grams of sugar sweetened cherry KOOL-AID and 500 mls of water. The carpet sample to be tested was placed on a flat, non-absorbent surface and a hollow brass cylinder having a 2-inch (5-cm) diameter was placed tightly over the carpet sample. Twenty mls. of the KOOL-AID staining solution was poured into the cylinder which had been previously placed on the carpet. The stain was gently worked into the carpet. The cylinder was then removed, and the stained carpet sample was allowed to sit undisturbed for 24 hours. Then the carpet was rinsed thoroughly under cold tap water for at least 10 minutes until the rinse water was clear. The carpet sample was extracted using a centrifuge, and air-dried for 24 hours on a flat, non-absorbent surface. The KOOL-AID stain obtained by this procedure was then rated. KOOL-AID stains were rated with a visual stain rating scale (AATCC Red 40 Stain Scale) from AATCC Test Method 175. A visual rating of 10 (complete stain removal) to 1 (maximum or unchanged stain) was obtained by using the AATCC Red 40 Stain Scale. Using this scale, a higher number indicates superior stain resistance.

### EXAMPLES

In the following examples all compositions used to treat substrates were aqueous solutions and contained an amount of water in weight % equal to [100% minus the total of the weight percentages of the other listed components]. Each treatment composition was prepared by mixing the components listed in water, and diluting to the desired concentration. Also in the following examples the control carpet used in each example was the same type and structure as detailed for the treated carpet. The abbreviation wpu means wet pick-up.

### Example 1

This example investigated the soil resist and stain resist performance of carpet constructed with dyed nylon fiber. An aqueous composition was prepared containing 0.52 weight % sodium alkyl sulfate surfactant, 4.0 weight % ZELAN 338, and the remainder water. The carpet used in this example consisted of a cut-pile carpet (32 oz/sq.yd., 1.09 kg/sq.m. The test composition was applied to a carpet which had received a hot water extraction cleaning and was applied to the carpet according to Application Method B. The control carpet for this example received a hot water extraction cleaning, but did not receive a treatment. Carpet samples were evaluated according to Test Methods 1 and 4. The resulting data are shown in Table 2.

### Example 2

This example investigated the soil resist and stain resist performance of carpet constructed with dyed nylon fiber. An aqueous composition was prepared containing 0.52 weight % sodium alkyl sulfate surfactant, 4.0 weight % ZELAN 338, 2.4 weight % polymethylmethacrylate, and the remainder water. The carpet used in this example consisted of a cut-pile carpet (32 oz/sq.yd., 1.09 kg/sq.m). The test composition was applied to a carpet which had received a hot water extraction cleaning and was applied to the carpet according to Application Method B. The control carpet for this example received a hot water extraction cleaning, but did not receive a treatment. Carpet samples were evaluated according to Test Methods 1 and 4. The resulting data are shown in Table 2

### Example 3

This example investigated the soil resist and stain resist performance of carpet constructed with dyed nylon fiber. An aqueous composition was prepared containing 0.52 weight % sodium alkyl sulfate surfactant, 4.0 weight % ZELAN 338, 2.4 weight % polymethylmethacrylate, 3.2 weight % amorphous silicon dioxide, and the remainder water. The carpet used in this example consisted of a cut-pile carpet (32 oz/sq.yd., 1.09 kg/sq.m). The test composition was applied to a carpet which had received a hot water extraction cleaning and was applied according to Application Method B. The control carpet for this example received a hot water extraction cleaning, but did not receive a treatment. Carpet samples were evaluated according to Test Methods 1 and 4. The resulting data are shown in Table 2.

### Example 4

This example investigated the soil resist and stain resist performance of carpet constructed with dyed nylon fiber. An aqueous composition was prepared containing 0.52 weight % sodium alkyl sulfate surfactant, 4.0 weight % ZELAN 338, 3.2 weight % amorphous silicon dioxide, and the remainder water. The carpet used in this example consisted of a cut-pile carpet (32 oz/sq.yd., 1.09 kg/sq.m). The test composition was applied to a carpet which had received a hot water extraction cleaning and was applied to the carpet according to Application Method B. The control carpet for this example received a hot water extraction cleaning, but did not receive a treatment. Carpet samples were evaluated according to Test Methods 1 and 4. The resulting data are shown in Table 2.

TABLE 2
Soil Resistance and Stain Resistance

| | | Delta Delta E vs. |
|---|---|---|
| | | untreated carpet |
| Example | stain resistance | soil resistance |
| 1 | 6 | −3.9 |
| 2 | 6 | −3.3 |
| 3 | 5 | −6.2 |
| 4 | 6 | −5.3 |
| Comparative | 1 | |
| Untreated | | |

### Example 5

This example investigated the soil resist and stain resist performance of carpet constructed with nylon 6 fiber. An aqueous composition was prepared containing 3.2 weight % polymethylmethacrylate, 0.64 weight % sodium alkyl sulfate surfactant, 4.8 weight % ZELAN 338, and the remainder water. The carpet used in this example consisted of a level loop carpet (30 oz/sq.yd., 1.01 kg/sq.m). The control carpet for this example did not receive a treatment. The test composition was applied to the carpet according to Application Method A. Carpet samples were evaluated according to Test Methods 2 and 4. The resulting data are shown in Table 3.

### Example 6

This example investigated the soil resist and stain resist performance of carpet constructed with nylon 6 fiber. An aqueous composition was prepared containing 3.2 weight % polymethylmethacrylate, 0.64 weight % sodium alkyl sulfate surfactant, 4.8 weight % ZELAN 338, 4.0 weight % amorphous silicon dioxide, and the remainder water. The carpet used in this example consisted of a level loop carpet (30 oz/sq.yd., 1.01 kg/sq.m.). The control carpet for this example did not receive a treatment. The test composition was applied to the carpet according to Application Method A. Carpet samples were evaluated according to Test Methods 2 and 4. The resulting data are shown in Table 3.

### Example 7

This example investigated the soil resist and stain resist performance of carpet constructed with nylon 6 fiber. An aqueous composition was prepared containing 0.2 weight % sodium alkyl sulfate surfactant, 2.4 weight % ZELAN 338, 3.2 weight % polymethylmethacrylate, 1.0 weight % p-toluene sulfonic acid, and remainder of water. The carpet used in this example consisted of a level loop carpet (30 oz/sq.yd., 1.01 kg/sq.m.). The control carpet for this example did not receive a treatment. The test composition was applied to the carpet according to Application Method A. Carpet samples were evaluated according to Test Methods 2 and 4. The resulting data are shown in Table 3.

### Example 8

This example investigated the soil resist and stain resist performance of carpet constructed with nylon 6 fiber. An aqueous composition was prepared containing 0.28 weight % sodium alkyl sulfate surfactant, 2.0 weight % ZELAN 338, 0.4 weight % maleic anhydride solution, and the remainder water. The carpet used in this example consisted of a level loop carpet (30 oz/sq.yd., 1.01 kg/sq.m.). The control carpet for this example did not receive a treatment. The test composition was applied to the carpet according to Application Method A. Carpet samples were evaluated according to Test Methods 2 and 4. The resulting data are shown in Table 3.

TABLE 3
Soil Resistance and Stain Resistance

| | Soil resistance, | | |
|---|---|---|---|
| | Delta Delta E vs. | Soil resistance, | |
| | untreated carpet | Delta Delta E vs. | |
| | Floor traffic | untreated carpet | |
| | soil test | Floor traffic soil test | Stain |
| Example | 30,000 foot traffics | 90,000 foot traffics | resistance |
| 5 | −1.8 | −2.8 | 5 |
| 6 | −2.9 | −2.9 | 5 |
| 7 | −2.3 | −2.7 | 4 |
| 8 | −1.4 | −1.3 | 4 |
| Comparative | | | 1 |
| Untreated | | | |
| Control | | | |

### Example 9

This example investigated the soil resist and stain resist performance of carpet constructed with nylon 6 fiber. An aqueous composition was prepared containing 2.0 weight % sulfonated aromatic condensate, 0.64 weight % sodium alkyl sulfate surfactant, 2.4 weight % ZELAN 338, 1.4 weight % amorphous silicon dioxide, and the remainder water. Carpet used in this example consisted of a level loop carpet (30 oz/sq.yd., 1.01 kg/sq.m.). The control carpet for this example did not receive a treatment. The test composition was applied to the carpet according to Application Method A. Carpet samples were evaluated according to Test Methods 2 and 4. The resulting data are shown in Table 4.

### Example 10

This example investigated the soil resist and stain resist performance of carpet constructed with nylon 6. An aqueous composition was prepared containing 2.0 weight % sulfonated aromatic condensate, 0.64 weight % sodium alkyl sulfate surfactant, 2.4 weight % ZELAN 338, 1.4 weight % amorphous silicon dioxide, 0.8 weight % citric acid, and the remainder water. Carpet used in this example consisted of a level loop carpet (30 oz/sq.yd., 1.01 kg/sq.m.). The control carpet for this example did not receive a treatment. The test composition was applied to the carpet according to Application Method A. Carpet samples were evaluated according to Test Methods 2 and 4. The resulting data are shown in Table 4.

### Example 11

This example investigated the soil resist and stain resist performance of carpet constructed with nylon 6 fiber. An aqueous composition was prepared containing 2.0 weight % sulfonated aromatic condensate, 0.64 weight % sodium alkyl sulfate surfactant, 2.4 weight % ZELAN 338, and the remainder water. Carpet used in this example consisted of a level loop carpet (30 oz/sq.yd., 1.01 kg/sq.m.). The control carpet for this example did not receive a treatment. The test composition was applied to the carpet according to Application Method A. Carpet samples were evaluated according to Test Methods 2 and 4. The resulting data are shown in Table 4.

TABLE 4
Soil Resistance and Stain Resistance

| | Soil resistance, | Soil resistance, | |
|---|---|---|---|
| | Delta Delta E vs. | Delta Delta E vs. | |
| | untreated carpet | untreated carpet | |
| | Floor traffic soil | Floor traffic soil | |
| | test 30,000 | test 90,000 | Stain |
| Example | foot traffics | foot traffics | resistance |
| 9 | −1.9 | −2.1 | 10 |
| 10 | −1.9 | −1.9 | 10 |
| 11 | −1.2 | −1.2 | 10 |
| Comparative | | | 1 |
| Untreated | | | |
| Control | | | |

### Example 12

This example investigated the soil resist and stain resist performance of carpet constructed with nylon 6 fiber. An aqueous composition was prepared containing 2.0 weight % sulfonated aromatic condensate, 0.32 weight % sodium alkyl sulfate surfactant, 2.4 weight % ZELAN 338, 0.8 weight % citric acid, and the remainder water. Carpet used in this example consisted of a level loop carpet (30 oz/sq.yd., 1.01 kg/sq.m.). The control carpet for this example did not receive a treatment. The test composition was applied to the carpet according to Application Method A. Carpet samples were evaluated according to Test Methods 2 and 4. The resulting data are shown in Table 5.

### Example 13

This example investigated the soil resist and stain resist performance of carpet constructed with nylon 6 fiber. An aqueous composition was prepared containing 2.0 weight % sulfonated aromatic condensate, 0.32 weight % sodium alkyl sulfate surfactant, and 2.4 weight % ZELAN 338, 1.2 weight % bio-based 1,3-propanediol, and the remainder water. Carpet used in this example consisted of a level loop carpet (30 oz/sq.yd., 1.01 kg/sq.m.). The control carpet for this example did not receive a treatment. The test composition was applied to the carpet according to Application Method A. Carpet samples were evaluated according to Test Methods 2 and 4. The resulting data are shown in Table 5.

TABLE 5
Soil Resistance and Stain Resistence

| | Soil resistance | Soil resistance | |
|---|---|---|---|
| | Delta Delta E vs. | Delta Delta E vs. | |
| | untreated carpet | untreated carpet | |
| | Floor traffic soil | Floor traffic soil | |
| | test 30,000 | test 90,000 | Stain |
| Example | foot traffics | foot traffics | resistance |
| 12 | −2.2 | −1.4 | 9.5 |
| 13 | −1.1 | −1.3 | 10 |
| Comparative | | | 1 |
| Untreated | | | |
| Control | | | |

### Example 14

This example investigated the soil resist and stain resist performance of residential carpet constructed with nylon 6,6 fiber which was treated with 1.2 weight % of a blend of sulfonated aromatic condensate and alkali metal salt of hydrolyzed octene/maleic anhydride copolymer stain resist. An aqueous composition was prepared containing 2.48 weight % preparation of ZP 9237, 6.0 weight % poly(methylmethacrylate)/2 polyethoxy ethyl methacrylate, 0.08 weight % dodecyl dimethyl ammonium acetate surfactant, and the remainder water. Carpet used in this example consisted of a cut-pile carpet (45 oz/sq.yd., 1.5 kg/sq.m.). Control carpet for this example did not receive a treatment. The treatment was applied to the carpet according to Application Method A. Carpet samples were evaluated according to Test Methods 1 and 4. Data are shown in Table 6.

### Example 15

This example investigated the soil resist and stain resist performance of residential carpet constructed with nylon 6,6 fiber which was treated with 1.2 weight % of a blend of sulfonated aromatic condensate and alkali metal salt of hydrolyzed octene/maleic anhydride copolymer stain resist. An aqueous composition was prepared containing 3.2 weight % polymethylmethacrylate, 2.0 weight % alpha olefin sulfonate surfactant, 6.8 weight % colloidal silica, and the remainder water. Carpet used in this example consisted of a cut-pile carpet (45 oz/sq.yd., 1.5 kg/sq.m.). Control carpet for this example did not receive a treatment. The treatment was applied to the carpet according to Application Method A. Carpet samples were evaluated according to Test Methods 1 and 4. Data are shown in Table 6.

### Example 16

This example investigated the soil resist and stain resist performance of residential carpet constructed with nylon 6,6 fiber which was treated with 1.2 weight % of a blend of sulfonated aromatic condensate and alkali metal salt of hydrolyzed octene/maleic anhydride copolymer stain resist. An aqueous composition was prepared containing 3.2 weight % polymethylmethacrylate, 2.0 weight % alpha olefin sulfonate surfactant, 8.0 weight % colloidal silica, and the remainder water. Carpet used in this example consisted of a cut-pile carpet (45 oz/sq.yd., 1.5 kg/sq.m.). Control carpet for this example did not receive a treatment. The treatment was applied to the carpet according to Application Method A. Carpet samples were evaluated according to Test Methods 1 and 4. Data are shown in Table 6.

### Example 17

This example investigated the soil resist and stain resist performance of residential carpet constructed with nylon 6,6 fiber which was treated with 1.2 weight % of a blend of sulfonated aromatic condensate and alkali metal salt of hydrolyzed octene/maleic anhydride copolymer stain resist. An aqueous composition was prepared containing 3.2 weight % polymethylmethacrylate, 2.08 weight % alpha olefin sulfonate surfactant, 8.0 weight % colloidal silica, and the remainder water. Carpet used in this example consisted of a cut-pile carpet (45 oz/sq.yd., 1.5 kg/sq.m.). Control carpet for this example did not receive a treatment. The treatment was applied to the carpet according to Application Method A. Carpet samples were evaluated according to Test Methods 1 and 4. Data are shown in Table 6.

### Example 18

This example investigated the soil resist and stain resist performance of residential carpet constructed with nylon 6,6 fiber which was treated with 1.2 weight % of a blend of sulfonated aromatic condensate and alkali metal salt of hydrolyzed octene/maleic anhydride copolymer stain resist. An aqueous composition was prepared containing 3.2 weight % polymethylmethacrylate, 2.08 weight % alpha olefin sulfonate surfactant, 8.0 weight % amorphous silica, and the remainder water. Carpet used in this example consisted of a cut-pile carpet (45 oz/sq.yd., 1.5 kg/sq.m.). Control carpet for this example did not receive a treatment. The treatment was applied to the carpet according to Application Method A. Carpet samples were evaluated according to Test Methods 1 and 4. Data are shown in Table 6.

### Example 19

This example investigated the soil resist and stain resist performance of residential carpet constructed with nylon 6,6 fiber. An aqueous composition was prepared containing 2.0 weight % sulfonated aromatic condensate, 0.6 weight % alpha olefin sulfonate surfactant, 2.0 weight % alkali metal salt of a hydrolyzed octene/maleic anhydride copolymer, 0.8 weight % citric acid, and the remainder water. Carpet used in this example consisted of a cut-pile carpet (45 oz/sq.yd., 1.5 kg/sq.m.). Control carpet for this example did not receive a treatment. The treatment was applied to the carpet according to Application Method A. Carpet samples were evaluated according to Test Methods 1 and 4. Data are shown in Table 6.

TABLE 6
Soil Resistance and Stain Resistance

| | | Soil resistance |
|---|---|---|
| | | Delta Delta E vs. |
| | | untreated carpet |
| Example | Stain resistance | drum soil test |
| 14 | 8 | −3.0 |
| 15 | 9 | −8.2 |
| 16 | 8 | −9.0 |
| 17 | 9 | −8.9 |
| 18 | 9 | −10.6 |
| 19 | 10 | −22.6 |
| Comparative | 1 | |

### Example 20 and Comparative Example A

The carpet used in this example consisted of nylon-6,6 fiber tufted into a residential cut pile construction. It was dyed beige and weighed 30 oz/sq.yd. (1.0 kg/sq.m). An aqueous composition was prepared containing 0.28 weight % of PERMAGUARD ESR-2128, and 0.62 weight % of SILSURF. The treatment was applied to the carpet as an aqueous composition at 325% wet pick up (wpu) according to Application Method 1. The comparative example A control carpet for this example did not receive a treatment.

Carpet samples were evaluated according to Test Methods 1 and 4. The resulting data are shown in Table 7.

TABLE 7
Soil Resistance and Stain Resistance

| | Soil resistance | |
|---|---|---|
| | Delta Delta E vs. | |
| | Untreated carpet | Stain |
| Example | Drum Soil Test | resistance |
| Example 20 | −10.75 | 9.5 |
| Comparative | | 1 |
| Example A | | |
| Untreated | | |

### Examples 21-24 and Comparative Example B

The carpet used in these examples consisted of nylon-6,6 fiber tufted into a residential cut pile construction. It was dyed beige and weighed 30 oz/sq.yd. (1.0 kg/sq.m). For example 21, an aqueous composition was prepared containing 0.97 weight % of PERMAGUARD ESR-2128, and 0.94 weight % of SILSURF A004. For example 22, an aqueous composition was prepared containing 1.11 weight % of PERMAGUARD ESR-2128, and 0.63 weight % of SILSURF A008. For example 23, an aqueous composition was prepared containing 0.83 weight % of PERMAGUARD ESR-2128 and 1.25 weight % of SILSURF A008. For example 24, an aqueous composition was prepared containing 1.11 weight % of PERMAGUARD ESR-2128, and 0.63 weight % of SILSURF A012. These compositions were applied to the carpet as aqueous compositions at a rate of 1 gallon of diluted composition per 200 sq. ft. of carpet according to Application Method 3. The Comparative Example B carpet did not receive a treatment. Carpet samples were evaluated according to Test Methods 1 and 4. The resulting data are shown in Table 8.

TABLE 8
Soil Resistance and Stain Resistance

| | Soil resistance | |
|---|---|---|
| | Delta Delta E vs. | |
| | Untreated carpet | Stain |
| Example | Drum Soil Test | resistance |
| Example 21 | −4.64 | 4.5 |
| Example 22 | −11.04 | 7 |
| Example 23 | −9.32 | 8 |
| Example 24 | −10.17 | 7 |
| Comparative | | 1 |
| Example B | | |
| Untreated | | |

### Example 25

This example investigated the soil resist and stain resist performance of carpet constructed with nylon 6,6 fiber. An aqueous composition was prepared containing 1.0 weight % sulfonated aromatic condensate, 0.16 weight % sodium alkyl sulfate surfactant, 1.2 weight % ZELAN 338, 0.4 weight % citric acid, and the remainder water. Carpet used in this example consisted of a residential carpet (45 oz/sq.yd., 1.5 kg/sq.m.). Control carpet for this example did not receive a treatment. The test composition was applied to the carpet according to Application Method A with a spray application at 25% and was dried to a carpet face temperature of 250° F. (121° C.). Carpet samples were evaluated according to Test Methods 1 and 4. The resulting data are shown in Table 9.

### Example 26

This example investigated the soil resist and stain resist performance of carpet constructed with nylon 6,6 fiber. An aqueous composition was prepared containing 1.0 weight % sulfonated aromatic condensate, 0.16 weight % sodium alkyl sulfate surfactant, 1.2 weight % ZELAN 338, 0.4 weight % citric acid, and the remainder water. Carpet used in this example consisted of a residential carpet (45 oz/sq.yd., 1.5 kg/sq.m.). Control carpet for this example did not receive a treatment. The test composition was applied to the carpet according to Application Method B with a spray application at 25%. Carpet samples were evaluated according to Test Methods 1 and 4. The resulting data are shown in Table 9.

### Example 27

This example investigated the soil resist and stain resist performance of carpet constructed with nylon 6,6 fiber. An aqueous composition was prepared containing 0.48 weight % sulfonated aromatic condensate, 0.08 weight % sodium alkyl sulfate surfactant, 0.6 weight % ZELAN 338, 0.2 weight % citric acid, and the remainder water. Carpet used in this example consisted of a residential carpet (45 oz/sq.yd., 1.5 kg/sq.m.). Control carpet for this example did not receive a treatment. The test composition was applied to the carpet according to Application Method A with a spray application at 25% and was dried to a carpet face temperature of 250° F. (121° C.). Carpet samples were evaluated according to Test Methods 1 and 4. The resulting data are shown in Table 9.

### Example 28

This example investigated the soil resist and stain resist performance of carpet constructed with nylon 6,6 fiber. An aqueous composition was prepared containing 0.48 weight % sulfonated aromatic condensate, 0.08 weight % sodium alkyl sulfate surfactant, 0.6 weight % ZELAN 338, 0.2 weight % citric acid, and the remainder water. Carpet used in this example consisted of a residential carpet (45 oz/sq.yd., 1.5 kg/sq.m.). Control carpet for this example did not receive a treatment. The test composition was applied to the carpet according to Application Method B with a spray application at 25% Carpet samples were evaluated according to Test Methods 1 and 4. The resulting data are shown in Table 9.

### Example 29

This example investigated the soil resist and stain resist performance of carpet constructed with nylon 6 fiber. An aqueous composition was prepared containing 2.0 weight % sulfonated aromatic condensate, 0.32 weight % alpha olefin sulfonate surfactant, 2.4 weight % ZELAN 338, 0.8 weight % citric acid, and the remainder water. The carpet used in this example consisted of a level loop carpet (30 oz/sq.yd., 1.01 kg/sq.m.). Control carpet for this example did not receive a treatment. The test composition was applied to the carpet according to Application Method A with a spray application at 25% and was dried to a carpet face temperature of 250° F. (121° C.). Carpet samples were evaluated according to Test Methods 1 and 4. The resulting data are shown in Table 9.

### Example 30

This example investigated the soil resist and stain resist performance of carpet constructed with nylon 6 fiber. An aqueous composition was prepared containing 2.0 weight % sulfonated aromatic condensate, 0.32 weight % alpha olefin sulfonate surfactant, 2.4 weight % ZELAN 338, 0.8 weight % citric acid, and the remainder water. Carpet used in this example consisted of a level loop carpet (30 oz/sq.yd., 1.01 kg/sq.m.), Control carpet for this example did not receive a treatment. The test composition was applied to the carpet according to Application Method B with a spray application at 25% and was dried. Carpet samples were evaluated according to Test Methods 1 and 4. The resulting data are shown in Table 9.

TABLE 9
Soil Resistance and Stain Resistance

| | | Soil resistance |
|---|---|---|
| | | Delta Delta E vs. |
| | Stain | untreated carpet |
| Example | Resistance | drum soil test |
| 25 | 6 | −12.5 |
| 26 | 7 | −15.0 |
| 27 | 5 | −11.4 |
| 28 | 6 | −15.4 |
| 29 | 8 | −17.3 |
| 30 | 9 | −14.0 |
| Untreated | 1 | |

### Example 31

This example investigated the soil resist and stain resist performance of carpet constructed with nylon 6 fiber. An aqueous composition was prepared containing 1.72 weight % methylene-linked condensation product of aromatic sulfonic acids and hydroxyaryl sulfone, 0.32 weight % sodium alkyl sulfate surfactant, 2.4 weight % ZELAN 338, 0.8 weight % citric acid, and the remainder water. Carpet used in this example consisted of a level loop carpet (30 oz/sq.yd., 1.01 kg/sq.m.). The control carpet for this example did not receive a treatment. The test composition was applied to the carpet according to Application Method A. Carpet samples were evaluated according to Test Methods 1 and 4. The resulting data are shown in Table 10.

### Example 32

This example investigated the soil resist and stain resist performance of carpet constructed with nylon 6 fiber. An aqueous composition was prepared containing 1.72 weight % ERIONAL LYN, 0.32 weight % sodium alkyl sulfate surfactant, 2.4 weight % ZELAN 338, 0.8 weight % citric acid, and the remainder water. Carpet used in this example consisted of a level loop carpet (30 oz/sq.yd., 1.01 kg/sq.m.). The control carpet for this example did not receive a treatment. The test composition was applied to the carpet according to Application Method A. Carpet samples were evaluated according to Test Methods 1 and 4. The resulting data are shown in Table 10.

### Example 33

This example investigated the soil resist and stain resist performance of carpet constructed with nylon 6 fiber. An aqueous composition was prepared containing 1.44 weight % of a blend of an alkali metal salt of a hydrolyzed octene/maleic anhydride copolymer and sulfonated aromatic condensate, 0.32 weight % sodium alkyl sulfate surfactant, 2.4 weight % ZELAN 338, 0.8 weight % citric acid, and the remainder water. Carpet used in this example consisted of a level loop carpet (30 oz/sq.yd., 1.01 kg/sq.m.). The control carpet for this example did not receive a treatment. The test composition was applied to the carpet according to Application Method A. Carpet samples were evaluated according to Test Methods 1 and 4. The resulting data are shown in Table 10.

### Example 34

This example investigated the soil resist and stain resist performance of carpet constructed with nylon 6 fiber. An aqueous composition was prepared containing 1.2 weight % of a blend of an alkali metal salt of a hydrolyzed octene/maleic anhydride copolymer, ZELAN 338, and sulfonated aromatic condensate; 0.32 weight % sodium alkyl sulfate surfactant; 2.4 weight % sodium salt of hydrolyzed styrene/maleic anhydride/cumene terpolymer, 0.8 weight % citric acid, and the remainder water. Carpet used in this example consisted of a level loop carpet (30 oz/sq.yd., 1.01 kg/sq.m.). The control carpet for this example did not receive a treatment. The test composition was applied to the carpet according to Application Method A. Carpet samples were evaluated according to Test Methods 1 and 4. The resulting data are shown in Table 10.

### Example 35

This example investigated the soil resist and stain resist performance of carpet constructed with nylon 6 fiber. An aqueous composition was prepared containing 2.52 weight % sulfonated phenolic resin, 0.32 weight % sodium alkyl sulfate surfactant, 2.4 weight % ZELAN 338, 0.8 weight % citric acid, and the remainder water. Carpet used in this example consisted of a level loop carpet (30 oz/sq.yd., 1.01 kg/sq.m.). The control carpet for this example did not receive a treatment. The test composition was applied to the carpet according to Application Method A. Carpet samples were evaluated according to Test Methods 1 and 4. The resulting data are shown in Table 10.

### Example 36

This example investigated the soil resist and stain resist performance of carpet constructed with nylon 6 fiber. An aqueous composition was prepared containing 2.32 weight % aromatic sulfonates, 0.32 weight % sodium alkyl sulfate surfactant, 2.4 weight % ZELAN 338, 0.8 weight % citric acid, and the remainder water. Carpet used in this example consisted of a level loop carpet (30 oz/sq.yd., 1.01 kg/sq.m.). The control carpet for this example did not receive a treatment. The test composition was applied to the carpet according to Application Method A. Carpet samples were evaluated according to Test Methods 1 and 4. The resulting data are shown in Table 10.

### Example 37

This example investigated the soil resist and stain resist performance of carpet constructed with nylon 6 fiber. An aqueous composition was prepared containing 2.0 weight % 3M FX-657, 0.32 weight % sodium alkyl sulfate surfactant, 2.4 weight % ZELAN 338, 0.8 weight % citric acid, and the remainder water. Carpet used in this example consisted of a level loop carpet (30 oz/sq.yd., 1.01 kg/sq.m.). The control carpet for this example did not receive a treatment. The test composition was applied to the carpet according to Application Method A. Carpet samples were evaluated according to Test Methods 1 and 4. The resulting data are shown in Table 30B.

TABLE 10
Soil Resistance and Stain Resistance

| | | Soil resistance |
|---|---|---|
| | | Delta Delta E vs. |
| | Stain | untreated carpet |
| Example | resistance | drum soil test |
| 31 | 10 | −21.2 |
| 32 | 9.5 | −23.1 |
| 33 | 9 | −19.9 |
| 34 | 9 | −24.2 |
| 35 | 9.5 | −19.0 |
| 36 | 10 | −15.6 |
| 37 | 9 | −18.5 |
| Untreated | 1 | |

### Example 38

This example investigated the soil resist and stain resist performance of carpet constructed with nylon fiber which was treated with 1.2 weight % of a blend of sulfonated aromatic condensate and alkali metal salt of hydrolyzed octene/maleic anhydride copolymer stain resist. An aqueous composition was prepared containing 0.96 weight % polymethylmethylmethacrylate and 0.028 weight % sulfonated alkyl benzene surfactant and 0.02 weight % UNIFROTH 0448 and 0.56 weight % preparation of RUCO EPV-2058, 0.80 weight % amorphous silica, and the remainder water. Carpet used in this example consisted of cut-pile carpet (30 oz/sq.yd., 1.0 kg/sq.m.). Control carpet for this example did not receive a treatment. The test composition was applied to the carpet according to Application Method B. Carpet samples were evaluated according to Test Methods 1 and 4. The resulting data are shown in Table 11.

TABLE 11
Soil Resistance and Stain Resistance

| | | Soil resistance |
|---|---|---|
| | | Delta Delta E vs. |
| | Stain | untreated carpet |
| Example | resistance | drum soil test |
| 38 | 10 | −1.4 |
| Untreated | 1 | |

For Tables 2 to 11, the Delta Delta E values were negative numbers. This indicated that the test carpet had better performance and less soiling than the control for each example. Thus, treatment with the compositions of the present invention provided or imparted soil resistance to the treated substrates. For Tables 2 to 11, the stain resistance value was higher for the examples compared to the control, thus indicating superior stain resistance for substrates treated by the examples of the present invention.

What is claimed is:

1. A composition comprising at least one of a surfactant, at least one of a nonfluorinated soil resist agent, and at least one of a stain resist agent, which imparts soil resistance and stain resistance to a substrate which has been contacted with said composition.

2. The composition of claim 1 wherein the soil resist agent is selected from the group consisting of an alkali metal salt of a hydrolyzed styrene/maleic anhydride copolymer or of a hydrolyzed styrene/maleic anhydride/cumene terpolymer; an alkali metal salt of a hydrolyzed octene/maleic anhydride copolymer; an ammonium salt of a hydrolyzed styrene/maleic anhydride copolymer or of a hydrolyzed styrene/maleic anhydride/cumene terpolymer; methyl methacrylate/ethyl methacrylate copolymer; polymethylmethacrylate; polymethacrylic acid; polystyrene; sulfonated polyester; polyester; carboxylated polymer; and a dispersion of inorganic particulate matter selected from the group consisting of clay, colloidal silica, titanium dioxide, colloidal alumina, zirconium oxide, amorphous silicon dioxide, and colloidal silica dioxide, and mixtures thereof.

3. The composition of claim 1 wherein the surfactant is selected from the group consisting of an alkali metal salt of alpha sulfonated carboxylic acid or ester; an alkali metal salt of 1-octane sulfonate; alkyl aryl sulfate; alkali metal alkyl diphenyloxide disulfonate; alkali metal salt of dimethyl-5-sulfoisophthalate; sodium butyl naphthalene sulfonate; C₁₆-C₁₈ phosphate salt; salt of condensed naphthalene formaldehyde sulfonate; salt of dodecyl benzene sulfonate (branched); salt of alkyl sulfate; alpha olefin sulfonate; salt of dodecyl diphenyloxide disulfonate; polyoxyethylene (20) cetyl ester; ethoxylated alcohol; alkyl dimethylamine; polyoxyethylene tridecyl ether; dodecyl ammonium acetate; and alkali metal salt of sulfonated 1,1 oxybis, tetrapropylene benzene.

4. The composition of claim 1 wherein the stain resist agent is selected from the group consisting of an alkali metal salt of a hydrolyzed styrene/maleic anhydride copolymer or of a hydrolyzed styrene/maleic anhydride/cumene terpolymer; an alkali metal salt of a hydrolyzed octene/maleic anhydride copolymer; an ammonium salt of a hydrolyzed styrene/maleic anhydride copolymer or of a hydrolyzed styrene/maleic anhydride/cumene terpolymer, sulfonated aromatic condensate, sulfonated phenolic resin, homopolymer of methacrylic acid, copolymer of methacrylic acid, blend of sulfonated aromatic condensate and alkali metal salt of hydrolyzed octene/maleic anhydride copolymer, methylene-linked condensate of aromatic sulfonic acid and hydroxyaryl sulfone, naphthalene sulfonic acid, polymer of formaldehyde and 4,4′sulfonyl bis[phenol], aromatic sulfonates, propyl ester of styrene maleic anhydride resin, and ammonium salt of styrene maleic anhydride resin.

5. The composition of claim 1 further comprising at least one of
A. an inorganic oxide selected from the group consisting of clay, colloidal silica, titanium dioxide, colloidal alumina, zirconium oxide, amorphous silicon dioxide, and colloidal silica dioxide,
B. a functional additive selected from the group consisting of soy protein; dipropylene glycol methyl ether; 1,3-propanediol; para-toluene sulfonic acid; maleic anhydride solution; citric acid; or polyester polyurethane dispersion, or
C. water.

6. The composition of claim 1 wherein the soil resist agent is present in the composition at from about 0.1 to about 30.0% by weight; the surfactant is present in the composition at from about 0.01 to about 10.0% by weight; and the stain resist agent is present in the composition at from about 0.1 to about 30.0% by weight.

7. The composition of claim 5 wherein the inorganic oxide is present at from about 0% to about 30% % by weight.

8. The composition of claim 5 wherein the functional additive is present at from 0% to 10% by weight.

9. The composition of claim 1 comprising:
1) 2.4 weight % polymethylmethacrylate, 0.52 weight % sodium alkyl sulfate surfactant, and 4.0 weight % sodium salt of hydrolyzed styrene/maleic anhydride/cumene terpolymer;
2) 2.4 weight % polymethylmethacrylate, 0.52 weight % sodium alkyl sulfate surfactant, 4.0 weight % sodium salt of hydrolyzed styrene/maleic anhydride/cumene terpolymer, and 3.2 weight % amorphous silicon dioxide;
3) 2.0 weight % sulfonated aromatic condensate, 0.32 weight % sodium alkyl sulfate surfactant, 2.4 weight % sodium salt of hydrolyzed styrene/maleic anhydride/cumene terpolymer, and 1.2 weight % bio-based 1,3-propanediol;
4) 2.0 weight % sulfonated aromatic condensate, 0.64 weight % sodium alkyl sulfate surfactant, 2.4 weight % sodium salt of hydrolyzed styrene/maleic anhydride/cumene terpolymer, 1.4 weight % amorphous silicon dioxide, and 0.8 weight % citric acid;
5) 2.0 weight % sulfonated aromatic condensate, 0.64 weight % sodium alkyl sulfate surfactant, 2.4 weight % sodium salt of hydrolyzed styrene/maleic anhydride/cumene terpolymer, and 1.4 weight % amorphous silicon dioxide; or
6) 2.0 weight % sulfonated aromatic condensate, 0.6 weight % alpha olefin sulfonate surfactant, 2.0 weight % alkali metal salt of hydrolyzed octene/maleic anhydride copolymer, 1.4 weight % amorphous silicon dioxide, and 0.8 weight % citric acid.

10. A method of imparting soil resistance and stain resistance to a substrate comprising contacting said substrate with a composition comprising at least one of a surfactant, at least one of a nonfluorinated soil resist agent, and at least one of a stain resist agent.

11. The method of claim 10 wherein the surfactant is selected from the group consisting of an alkali metal salt of alpha sulfonated carboxylic acid or ester; an alkali metal salt of 1-octane sulfonate; alkyl aryl sulfate; alkali metal alkyl diphenyloxide disulfonate; alkali metal salt of dimethyl-5-sulfoisophthalate; sodium butyl naphthalene sulfonate; C₁₆-C₁₈ phosphate salt; salt of condensed naphthalene formaldehyde sulfonate; salt of dodecyl benzene sulfonate (branched); salt of alkyl sulfate; alpha olefin sulfonate; salt of docecyl diphenyloxide disulfonate; polyoxyethylene (20) cetyl ester; ethoxylated alcohol; alkyl dimethylamine; polyoxyethylene tridecyl ether; dodecyl ammonium acetate; and alkali metal salt of sulfonated 1,1 oxybis, tetrapropylene benzene.

12. The method of claim 10 wherein the soil resist agent is selected from the group consisting of an alkali metal salt of a hydrolyzed styrene/maleic anhydride copolymer or of a hydrolyzed styrene/maleic anhydride/cumene terpolymer; an alkali metal salt of a hydrolyzed octene/maleic anhydride copolymer; an ammonium salt of a hydrolyzed styrene/maleic anhydride copolymer or of a hydrolyzed styrene/maleic anhydride/cumene terpolymer; methyl methacrylate/ethyl methacrylate copolymer; polymethylmethacrylate; polymethacrylic acid; polystyrene; sulfonated polyester; polyester; carboxylated polymer; and a dispersion of inorganic particulate matter selected from the group consisting of clay, colloidal silica, titanium dioxide, colloidal alumina, zirconium oxide, amorphous silicon dioxide, and colloidal silica dioxide, and mixtures thereof.

13. The method of claim 10 wherein the stain resist agent is selected from the group consisting of an alkali metal salt of a hydrolyzed styrene/maleic anhydride copolymer or of a hydrolyzed styrene/maleic anhydride/cumene terpolymer; an alkali metal salt of a hydrolyzed octene/maleic anhydride copolymer; an ammonium salt of a hydrolyzed styrene/maleic anhydride copolymer or of a hydrolyzed styrene/maleic anhydride/cumene terpolymer, sulfonated aromatic condensate, sulfonated phenolic resin, homopolymer of methacrylic acid, copolymer of methacrylic acid, blend of sulfonated aromatic condensate and alkali metal salt of hydrolyzed octene/maleic anhydride copolymer, methylene-linked condensate of aromatic sulfonic acid and hydroxyaryl sulfone, naphthalene sulfonic acid, polymer of formaldehyde and 4,4′sulfonyl bis[phenol], aromatic sulfonates, propyl ester of styrene maleic anhydride resin, and ammonium salt of styrene maleic anhydride resin.

14. The method of claim 10 wherein the composition further comprises:
A. an inorganic oxide selected from the group consisting of clay, colloidal silica, titanium dioxide, colloidal alumina, zirconium oxide, amorphous silicon dioxide, and colloidal silica dioxide,
B. a functional additive selected from the group consisting of soy protein; dipropylene glycol methyl ether; 1,3-propanediol; para-toluene sulfonic acid; maleic anhydride solution; citric acid; and polyester polyurethane dispersion, or
C. water.

15. The method of claim 10 comprising contacting said substrate with a composition wherein the soil resist agent is present in the composition at from about 0.1 to about 30.0% by weight; the surfactant is present in the composition at from about 0.01 to about 10.0% by weight; and the stain resist agent is present in the composition at from about 0.1 to about 30.0% by weight.

16. The method of claim 14 wherein the inorganic oxide is present at 0 to about 30% by weight of the composition and the functional additive is present at 0 to about 10% by weight of the composition.

17. A substrate having soil resistance and stain resistance which has been contacted with a composition comprising at least one of a surfactant, at least one of a nonfluorinated soil resist agent, and at least one of a stain resist agent.

18. The substrate of claim 17 which has been contacted with the composition further comprising at least one of an inorganic oxide or a functional additive.

19. The substrate of claim 17 which is a fibrous substrate.

20. The substrate of claim 19 which is selected from the group consisting of carpet, rugs, textiles, leather, paper, cellulosics, and nonwovens.

21. The substrate of claim 19 which is selected from the group consisting of a film, fiber, yarn, fabric, paint brush, paint roller, paint applicator, and other articles made from filaments, fibers, or yarns.
